(19) United States
(12) Patent Application Publication
(10) Pub. No.: US 2019/0030672 A1
(43) Pub. Date: Jan. 31, 2019

(54) Intelligent Detection Cutting Tool Structure

(71) Applicant: ZULEADSHIN ENTERPRISE CO., LTD., Taichung City (TW)

(72) Inventor: Chia-Liang Tseng, Taichung City (TW)

(21) Appl. No.: 15/658,469

(22) Filed: Jul. 25, 2017

(51) Int. Cl. B23Q 17/09; G05B 19/048

(52) U.S. Cl. CPC B23Q 17/0971; B23Q 17/098; G05B 2219/24015; G05B 19/048; B23Q 17/0985

(57) ABSTRACT

An intelligent detection cutting tool structure includes a cutting tool including a shank, a body and a detection device. The body is connected with the shank and has a cutting edge. The detection device is mounted on the shank and detects abnormal conditions during a working process of the cutting edge, and transmits a signal to a mobile device of an operator. Thus, when the cutting tool is mounted on the working machine to perform the working process, the detection device detects operation of the cutting tool during the working process and transmits the detected information to the mobile device, so that the operator can control the operating situation of the cutting tool, so as to calibrate, repair or replace the cutting tool according to the operating situation of the cutting tool.

### BACKGROUND OF THE INVENTION

### 1. Field of the Invention

The present invention relates to a working tool and, more particularly, to a cutting tool structure for working a workpiece.

### 2. Description of the Related Art

A conventional cutting tool is made of hard material and comprises a shank and a body. The body has a distal end provided with a cutting edge. In operation, the cutting tool is mounted on a machine tool (such as a mill or a drilling machine) which drives and rotates the cutting tool. The shank of the cutting tool is clamped by the chuck of the machine tool. When the cutting tool is driven and rotated by the machine tool, the cutting edge of the body of the cutting tool is rotated to work (such as mill or drill) a workpiece. If the cutting tool is worn out during a period of time, the working precision is decreased, so that it is necessary to replace the cutting tool before the cutting tool is worn out. In general, the wear limit of the cutting tool is judged by the experience of the operator or determined by the total operation hours of the cutting tool. However, when the wear limit of the cutting tool is judged by the existing experience, the operator cannot exactly judge the wear limit of the cutting tool. Thus, if the cutting tool is replaced before the wear limit, the material is wasted, and if the cutting tool is not replaced after the wear limit, the working quality is poor. In addition, when the wear limit of the cutting tool is determined by the total operation hours of the cutting tool, different cutting tools have different working conditions (such as different materials or different successive working periods), so that the wear limit of the cutting tool cannot be determined exactly by the total operation hours of the cutting tool.

### BRIEF SUMMARY OF THE INVENTION

The primary objective of the present invention is to provide a cutting tool structure having an intelligent detection function.

In accordance with the present invention, there is provided a intelligent detection cutting tool structure comprising a cutting tool including a shank, a body and a detection device. The shank is clamped by a chuck of a working machine. The body is connected with the shank and has a surface provided with a cutting edge for a cutting working procedure. The detection device is mounted on the shank. The detection device detects abnormal conditions during a working process of the cutting edge of the body, and transmits a signal to a mobile device of an operator, to remind the operator of the abnormal conditions.

The intelligent detection cutting tool structure further comprises an intermediate station connected with the detection device in a wireless transmission manner to receive the signal transmitted by the detection device. The intermediate station includes a processor which receives the signal transmitted by the detection device and transmits the signal of the detection device to the mobile device of the operator.

The detection device includes a power supply to supply an electric power, a circuit board coupled to and electrically connected with the power supply and provided with a control unit to control an operation of the detection device, a detector coupled to and electrically connected with the circuit board to detect the abnormal conditions during the working process of the cutting edge of the body and to transmit a detected information to the control unit of the circuit board, and a transmission module coupled to and electrically connected with the control unit of the circuit board to receive and transmit the detected information transmitted by the control unit of the circuit board.

According to the primary advantage of the present invention, when the cutting tool is mounted on the working machine to perform the working process, the detection device detects operation of the cutting tool during the working process and produces and transmits the detected information to the mobile device of the operator, so that the operator can control the operating situation of the cutting tool, so as to calibrate, repair or replace the cutting tool according to the operating situation of the cutting tool.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a cross-sectional view of a cutting tool of an intelligent detection cutting tool structure in accordance with the first preferred embodiment of the present invention.

FIG. 2 is a cross-sectional view of a cutting tool of the intelligent detection cutting tool structure in accordance with the second preferred embodiment of the present invention.

FIG. 3 is a top view of the cutting tool of the intelligent detection cutting tool structure as shown in FIG. 2.

FIG. 4 is a cross-sectional view of a cutting tool of the intelligent detection cutting tool structure in accordance with the third preferred embodiment of the present invention.

FIG. 5 is a cross-sectional view of a cutting tool of the intelligent detection cutting tool structure in accordance with the fourth preferred embodiment of the present invention.

FIG. 6 is a cross-sectional view of a shank of the cutting tool of the intelligent detection cutting tool structure in accordance with another preferred embodiment of the present invention.

FIG. 7 is a block diagram of a detection device of the intelligent detection cutting tool structure in accordance with the preferred embodiment of the present invention.

FIG. 8 is a schematic operational view of the intelligent detection cutting tool structure in accordance with the first preferred embodiment of the present invention.

FIG. 9 is a schematic operational block diagram of the intelligent detection cutting tool structure in accordance with the first preferred embodiment of the present invention.

FIG. 10 is another schematic operational view of the intelligent detection cutting tool structure in accordance with the first preferred embodiment of the present invention.

FIG. 11 is another schematic operational block diagram of the intelligent detection cutting tool structure in accordance with the first preferred embodiment of the present invention.

### DETAILED DESCRIPTION OF THE INVENTION

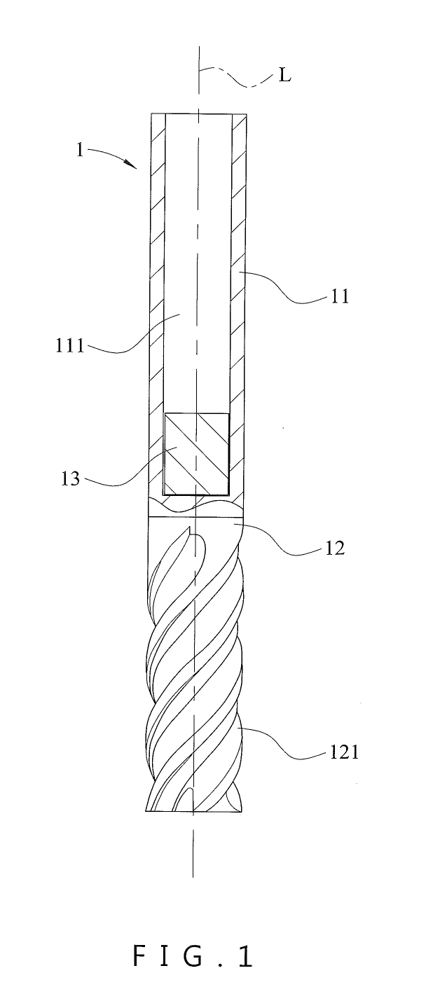

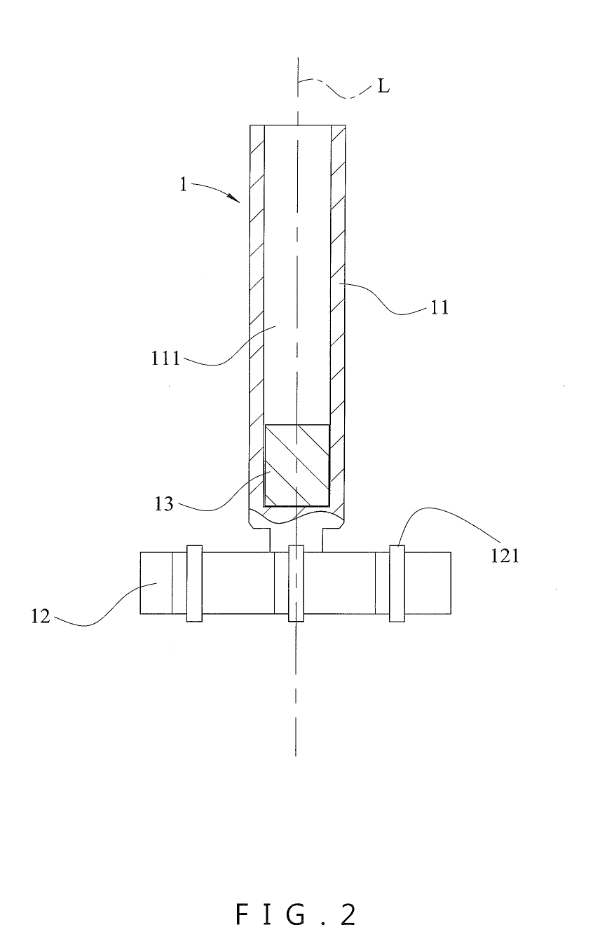

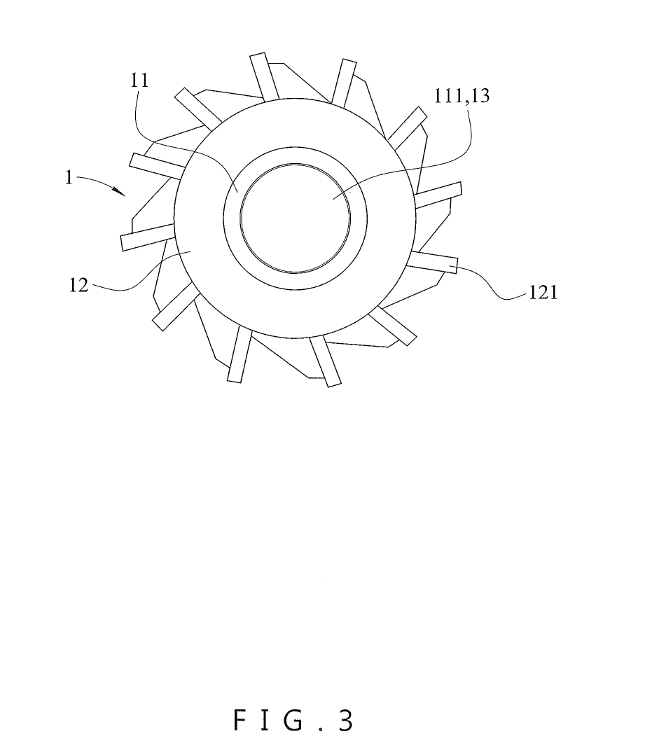

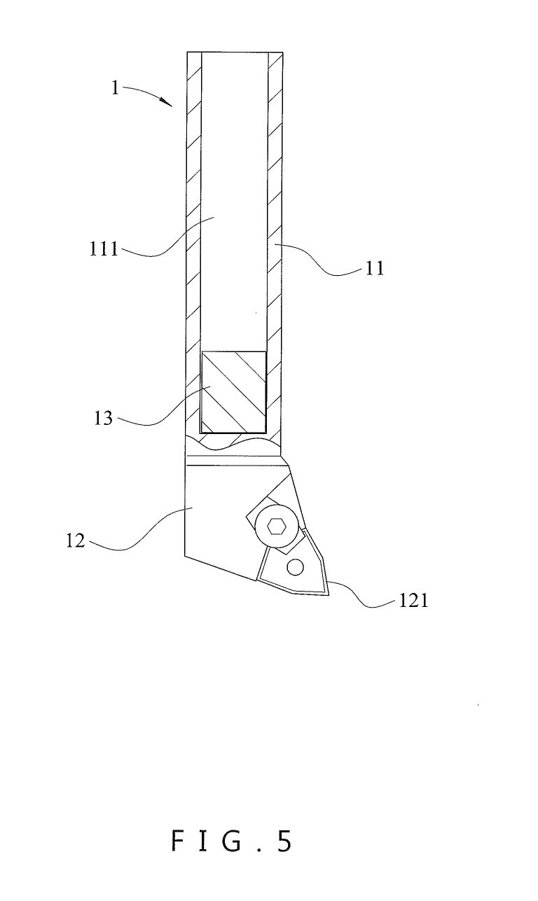

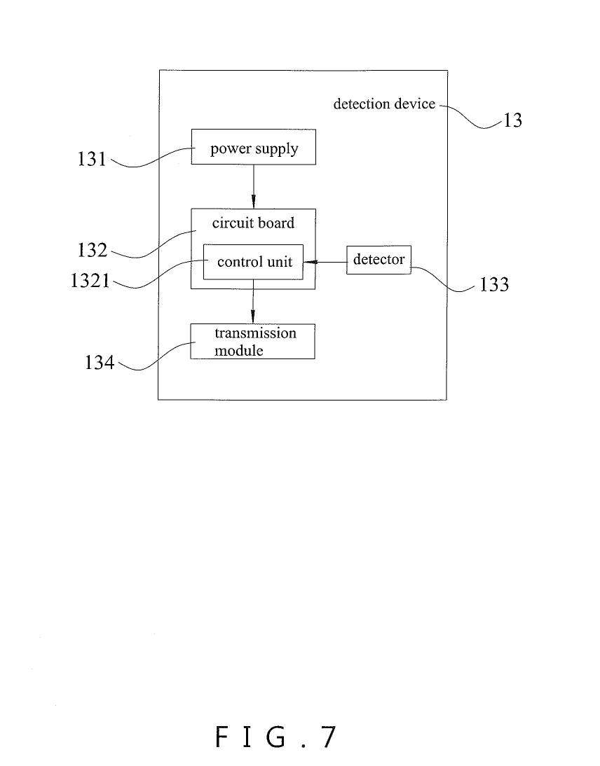

Referring to the drawings and initially to FIGS. 1-9, an intelligent detection cutting tool structure in accordance with the preferred embodiment of the present invention comprises a cutting tool 1 including a shank 11, a body 12 and a detection device 13.

The shank 11 is made of steel or iron having a predetermined shape. The shank 11 is clamped by a chuck of a working machine (not shown).

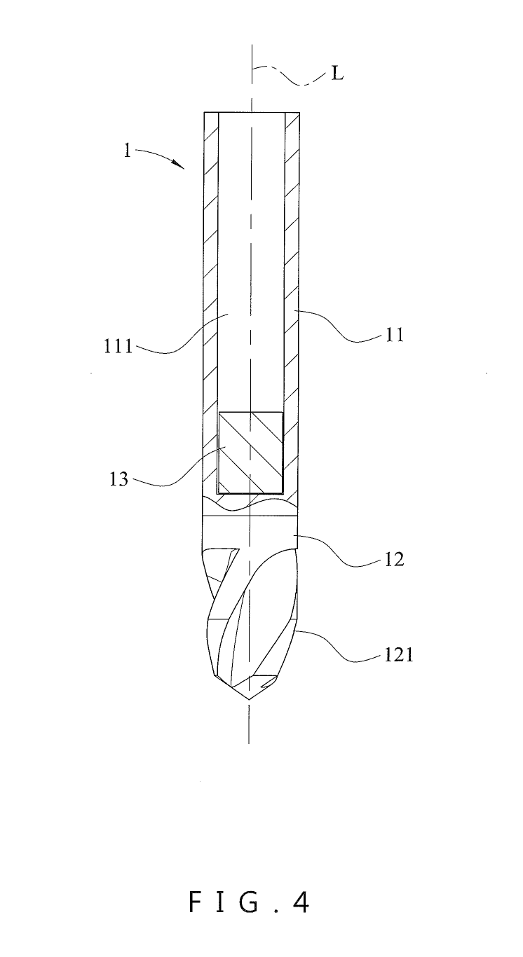

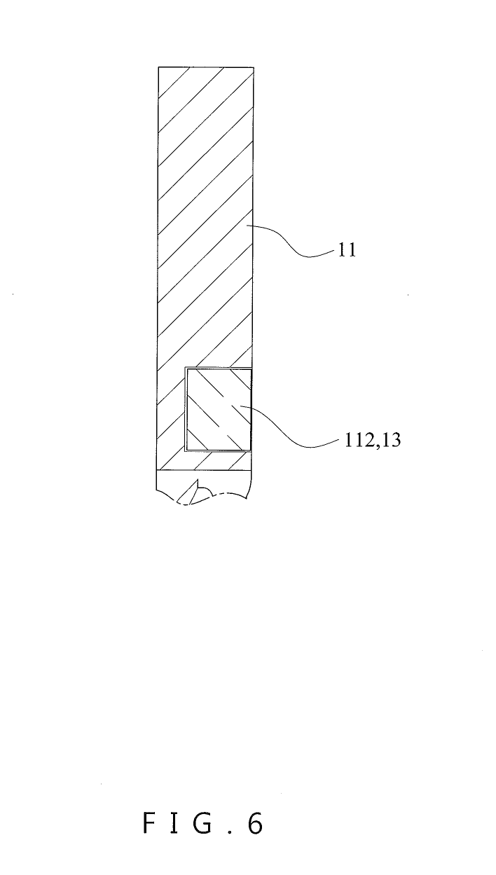

The body 12 is made of steel or iron having a predetermined shape. The body 12 is connected with the shank 11 and has a surface provided with a cutting edge 121 for a cutting working procedure. The body 12 matches with the shank 11 so that the cutting tool 1 functions as a milling tool as shown in FIGS. 1-3, a drilling tool as shown in FIG. 4, a turning tool as shown in FIG. 6 or other cutting tool.

The detection device 13 is mounted on a predetermined position of the shank 11. The detection device 13 detects abnormal conditions during a working process of the cutting edge 121 of the body 12, and transmits a signal to a mobile device 3 of an operator, to remind the operator of the abnormal conditions.

In the preferred embodiment of the present invention, the detection device 13 includes a power supply 131 to supply an electric power, a circuit board 132 coupled to and electrically connected with the power supply 131 and provided with a control unit 1321 to control an operation of the detection device 13, a detector 133 coupled to and electrically connected with the circuit board 132 to detect the abnormal conditions during the working process of the cutting edge 121 of the body 12 and to transmit a detected information to the control unit 1321 of the circuit board 132, and a transmission module 134 coupled to and electrically connected with the control unit 1321 of the circuit board 132 to receive and transmit the detected information transmitted by the control unit 1321 of the circuit board 132.

In the preferred embodiment of the present invention, the transmission module 134 of the detection device 13 is connected to the mobile device 3 in a wireless transmission manner by a bluetooth or WiFi.

In the preferred embodiment of the present invention, the mobile device 3 is a smart cell phone, a tablet computer, a personal computer or PDA.

In the preferred embodiment of the present invention, the shank 11 and the body 12 are connected in a combination manner or in an integral manner.

In the preferred embodiment of the present invention, when the shank 11 and the body 12 are connected in a combination manner, the shank 11 and the body 12 are connected by soldering, screwing or insertion.

In the preferred embodiment of the present invention, the shank 11 has a top provided with a receiving space 111 extending into the shank 11, and the detection device 13 is secured in the receiving space 111 of the shank 11.

In another preferred embodiment of the present invention, the shank 11 has a side provided with a receiving hole 112, and the detection device 13 is secured in the receiving space 111 of the shank 11 as shown in FIG. 6.

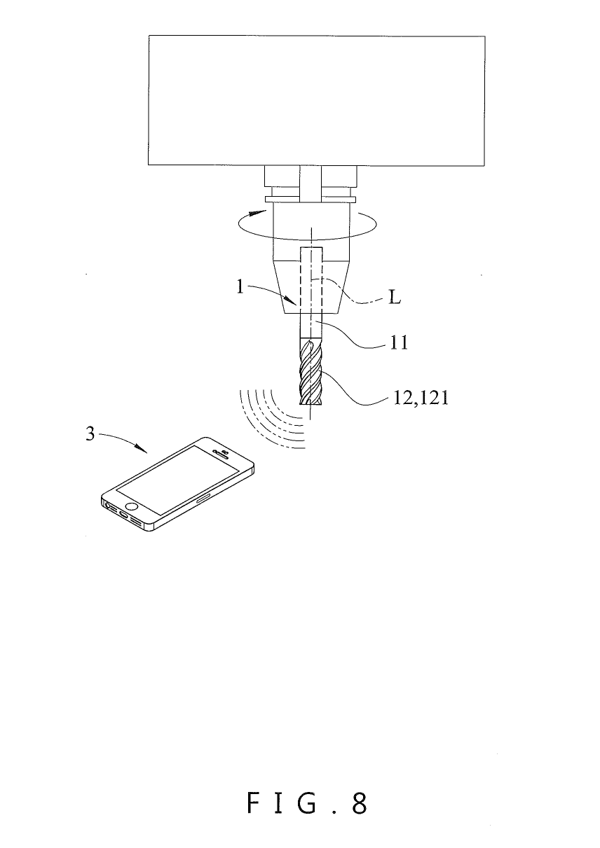

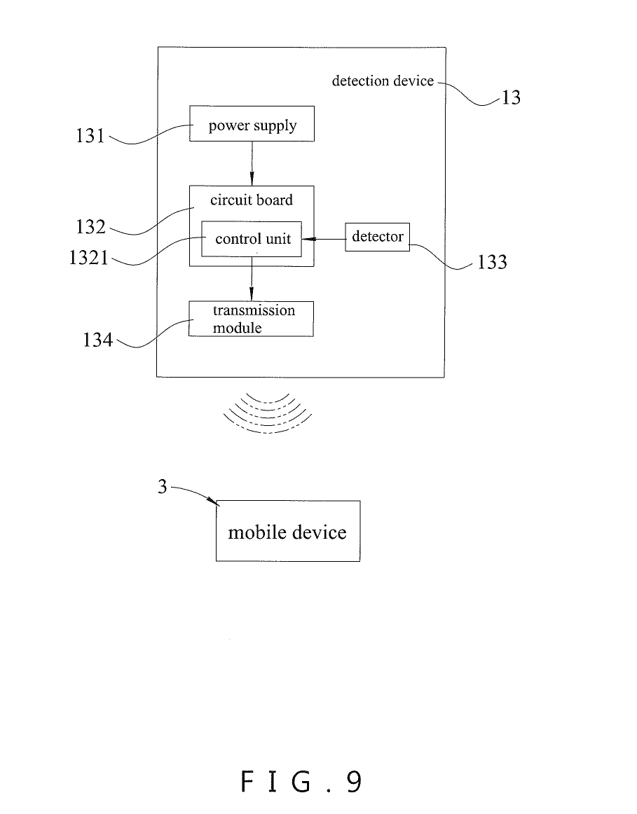

In operation, referring to FIGS. 8 and 9 with reference to FIGS. 1-7, the cutting tool 1 is mounted on the working machine which drives and rotates the cutting tool 1. The shank 11 of the cutting tool 1 is clamped by the chuck of the working machine. When the cutting tool 1 is driven by the working machine to rotate along an axis “L”, the cutting edge 121 of the body 12 is rotated to work the surface of a workpiece (not shown), such as turning, grinding, milling or drilling. At this time, the detector 133 of the detection device 13 detects the abnormal conditions during the working process of the cutting edge 121 of the body 12. In such a manner, when the detector 133 of the detection device 13 detects one of the abnormal conditions during the working process of the cutting edge 121 of the body 12, the detector 133 transmits the detected information to the control unit 1321 of the circuit board 132, and the control unit 1321 of the circuit board 132 transmits the detected information to the transmission module 134, and finally the transmission module 134 transmits the detected information to the mobile device 3, so that the operator can control the operating situation of the cutting tool 1. Thus, when the cutting tool 1 is mounted on the working machine to perform the working process, the detection device 13 detects operation of the cutting tool 1 and transmits the detected information to the mobile device 3 of the operator, so that the operator can judge if it is necessary to calibrate, repair or replace the cutting tool 1 according to the operating situation of the cutting tool 1.

It is appreciated that, the abnormal conditions produced during the working process of the cutting edge 121 of the body 12 includes abnormalities of the working temperature during cutting, the sound during cutting and the vibration during cutting.

1. When the temperature is too high during the working process, the cutting edge 121 of the body 12 is easily worn out, thereby decreasing the productivity, and decreasing the working precision. In addition, a residual stress easily produces on the worked surface when the temperature is too high during the working process.

2. When the workpiece has hard particles or the cutting edge 121 of the body 12 is worn out, the cutting process becomes unsteady, and the cutting sound is changed, which means that a hitting sound produces between the workpiece and the cutting edge 121 of the body 12.

3. When a tiny gap is defined between the shank 11 of the cutting tool 1 and the chuck of the working machine, the cutting tool 1 possibly produces vibration during the working process, so that the cutting edge 121 of the body 12 has an unevenly distributed force, and the cutting expansion amount is greater than the predetermined value, thereby decreasing the working precision and the lifetime of the cutting tool 1.

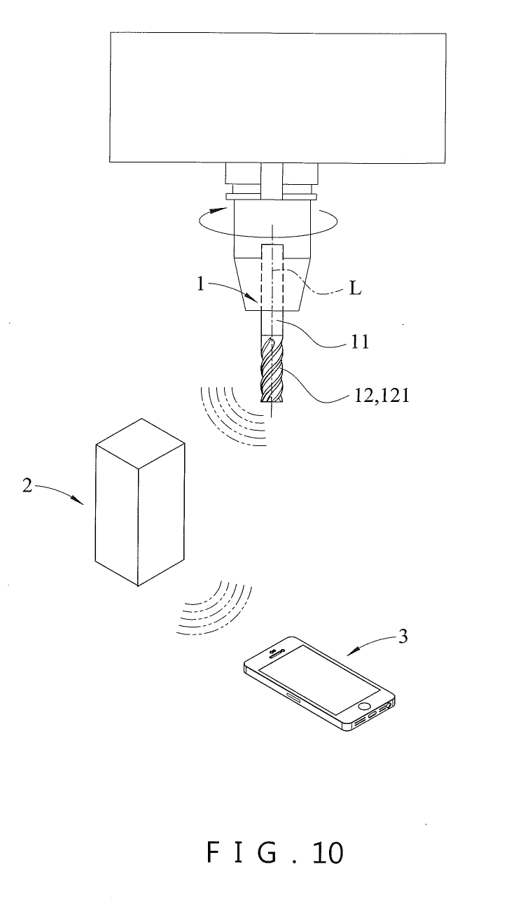

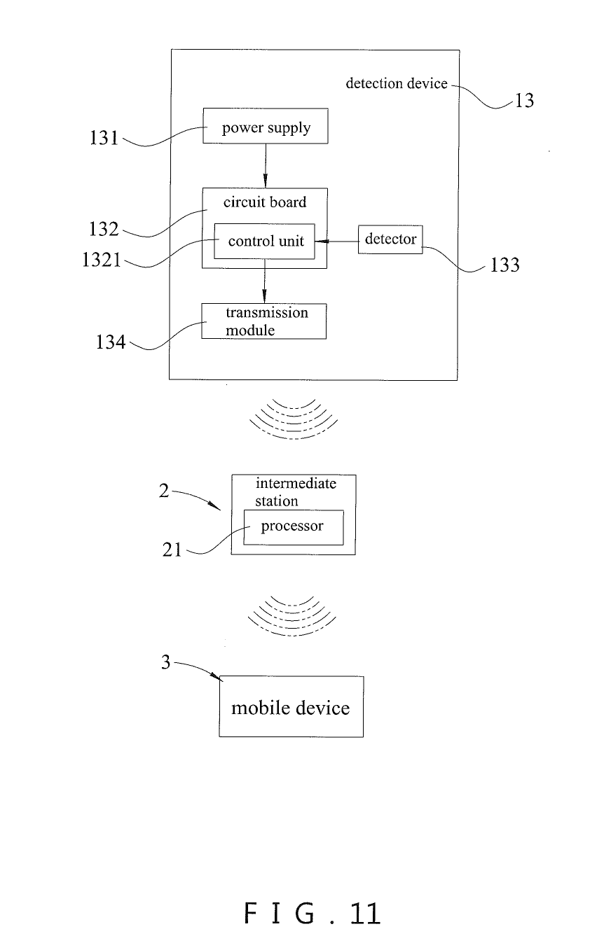

Referring to FIGS. 10 and 11 with reference to FIGS. 1-7, the intelligent detection cutting tool structure further comprises an intermediate station 2 connected with the detection device 13 in a wireless transmission manner to receive the signal transmitted by the detection device 13. The intermediate station 2 includes a processor 21 which receives the signal transmitted by the detection device 13 and transmits the signal of the detection device 13 to the mobile device 3 of the operator. Thus, the detection device 13 has a longer transmission distance by provision of the intermediate station 2. Preferably, the detection device 13, the intermediate station 2 and the mobile device 3 are connected in a wireless transmission manner by a bluetooth or WiFi.

In operation, the cutting tool 1 is mounted on the working machine which drives and rotates the cutting tool 1. The shank 11 of the cutting tool 1 is clamped by the chuck of the working machine. When the cutting tool 1 is driven by the working machine to rotate along an axis “L”, the cutting edge 121 of the body 12 is rotated to work the surface of a workpiece (not shown), such as turning, grinding, milling or drilling. At this time, the detector 133 of the detection device 13 detects the abnormal conditions during the working process of the cutting edge 121 of the body 12. In such a manner, when the detector 133 of the detection device 13 detects one of the abnormal conditions during the working process of the cutting edge 121 of the body 12, the detector 133 transmits the detected information to the control unit 1321 of the circuit board 132, and the control unit 1321 of the circuit board 132 transmits the detected information to the transmission module 134. Then, the transmission module 134 transmits the detected information to the processor 21 of the intermediate station 2. Finally, the processor 21 of the intermediate station 2 transmits the signal of the detection device 13 to the mobile device 3, so that the operator can control the operating situation of the cutting tool 1. In such a manner, the detection device 13 has a longer transmission distance by provision of the intermediate station 2. Thus, when the cutting tool 1 is mounted on the working machine to perform the working process, the detection device 13 detects operation of the cutting tool 1 and transmits the detected information through the intermediate station 2 to the mobile device 3 of the operator, so that the operator can judge if it is necessary to calibrate, repair or replace the cutting tool 1 according to the operating situation of the cutting tool 1.

Accordingly, when the cutting tool 1 is mounted on the working machine to perform the working process, the detection device 13 detects operation of the cutting tool 1 during the working process and produces and transmits the detected information to the mobile device 3 of the operator, so that the operator can control the operating situation of the cutting tool 1, so as to calibrate, repair or replace the cutting tool 1 according to the operating situation of the cutting tool 1.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the scope of the invention.

1. A cutting tool structure comprising:
a cutting tool including a shank, a body and a detection device;
wherein:
the shank is clamped by a chuck of a working machine;
the body is connected with the shank and has a surface provided with a cutting edge for a cutting working procedure;
the detection device is mounted on the shank; and
the detection device includes a power supply to supply an electric power, a circuit board coupled to and electrically connected with the power supply and provided with a control unit to control an operation of the detection device, a detector coupled to and electrically connected with the control unit of the circuit board, and a transmission module coupled to and electrically connected with the control unit of the circuit board.

2. The cutting tool structure of claim 1, further comprising:
an intermediate station disposed outside of and wireless connected with the transmission module of the detection device;
wherein:
the intermediate station includes a processor wireless connected with a mobile device.

3-6. (canceled)

7. The cutting tool structure of claim 1, wherein the shank and the body are connected to each other or formed integrally.

8. The cutting tool structure of claim 7, wherein when the shank and the body are connected to each other, the shank and the body are connected by soldering, screwing or insertion.

9. The cutting tool structure of claim 1, wherein the shank has a top provided with a receiving space extending into the shank, and the detection device is secured in the receiving space of the shank and close to a connection of the shank and the body.

10. The cutting tool structure of claim 1, wherein the shank has a side provided with a receiving hole, and the detection device is secured in the receiving space of the shank and close to a connection of the shank and the body.
